(19) United States
(12) Patent Application Publication
(10) Pub. No.: US 2023/0281701 A1
(43) Pub. Date: Sep. 7, 2023

(54) Monitoring system, monitoring method, and non-transitory computer medium for monitoring system

(71) Applicant: SHIRUSHI Inc, TOKYO (JP)

(72) Inventors: Yoshiro SHIMODA, TOKYO (JO); Hiroto TAKENO, KANAGAWA (JP); HideokI NAGAI, TOKYO (JP)

(21) Appl. No.: 18/157,466

(22) Filed: Jan. 20, 2023

(30) Foreign Application Priority Data
Jan. 20, 2022 (JP) 2022-007164

(51) Int. Cl. G06Q 30/0601; G06Q 30/0251

(52) U.S. Cl. CPC G06Q 30/0643; G06Q 30/0256

(57) ABSTRACT

A system that is configured to be communicable with a user terminal used by a user of a service provided by a system and a mall management server that provides a mall-type shopping site via a network and monitors the mall-type shopping site includes an extraction processing unit that accesses the mall-type shopping site and extracts a product having an image same as or similar to at least a part of an image of a predetermined product, and a determination processing unit that determines presence of inappropriate selling for the predetermined product based on selling information of the extracted product.

### BACKGROUND

### Technical Field

The present invention relates to a technique of monitoring a selling status of a product in a mall-type shopping site.

### Related Art

Conventionally, EC sites that sell products and services on the Internet are provided by various operators. Sellers of products and services try to expand sales opportunities of the products and services by selling the products and services on an EC site, but a mechanism for securing a safe and fair transaction is required on the EC site as a large number of sellers enter.

In this regard, for example, WO 2003-98510 discloses a system for mediating product trading using a communication network, the system including: at least one of a seller information recording means that records information related to a seller who sells a product in the system and a product examination information recording means that records information for examining a product to be sold in the system; and a selling determination means that determines whether selling can be performed by referring to the seller information recording means and the product examination information recording means when receiving information related to a seller who wishes to sell a product in the system and the product.

In the technique described in WO 2003-98510, an operator of an EC site can determine illegal selling on the EC site, but there is also a request from a product provider side such as a product manufacturer to monitor the distribution of the own product or the like in a mall-type shopping site not under its control and to perform safe and fair transaction of the product provided by itself.

Therefore, an object of the present invention is to monitor a selling status of a predetermined product and to provide information according to the selling status to a provider of the predetermined product in a mall-type shopping site not under its control.

### SUMMARY

In order to achieve the above object, a monitoring system according to one aspect of the present invention is a monitoring system that is communicably connected to a user terminal used by a user of a service provided by the system and a mall management server that provides a mall-type shopping site via a network and monitors the mall-type shopping site, the system including: an extraction processing unit that accesses the mall-type shopping site and extracts a product having an image same as or similar to at least a part of an image of a predetermined product; and a determination processing unit that determines presence of inappropriate selling for the predetermined product based on selling information of the extracted product.

The selling information may include at least product identification information for identifying the predetermined product, the user may include a whitelist storage unit that stores a whitelist related to the product identification information of the predetermined product, and the determination processing unit may determine a product that does not have appropriate product identification information of the predetermined product as an inappropriate selling with reference to the whitelist on the basis of the selling information.

The extraction processing unit may refer to a search word associated with the predetermined product in advance, execute a search using the search word in the mall-type shopping site, and extract selling information of a product having an image same as or similar to at least a part of an image of the predetermined product among products displayed in a search result of the search.

The extraction processing unit may execute the search using an algorithm similar to a search algorithm used by a purchaser who intends to purchase in the mall-type shopping site.

In order to achieve the above object, a monitoring method according to another aspect of the present invention is a monitoring method for allowing a system configured to be communicable with a user terminal used by a user of a service provided by the system and a mall management server that provides a mall-type shopping site via a network to monitor the mall-type shopping site, the method allowing the system to execute: extraction processing of accessing the mall-type shopping site and extracting a product having an image same as or similar to at least a part of an image of a predetermined product; and determination processing of determining whether there is inappropriate selling for the predetermined product based on selling information of the extracted product.

In order to achieve the above object, a non-transitory computer medium for a monitoring system according to still another aspect of the present invention is a computer program for allowing a system configured to be communicable with a user terminal used by a user of a service provided by the system and a mall management server that provides a mall-type shopping site via a network to monitor the mall-type shopping site, the computer program allowing the system to execute: extraction processing of accessing the mall-type shopping site and extracting a product having an image same as or similar to at least a part of an image of a predetermined product; and determination processing of determining whether there is inappropriate selling for the predetermined product based on selling information of the extracted product.

Note that the computer program can be provided by being stored in various data readable recording media, or can be provided in a downloadable manner via a network such as the Internet.

According to the present invention, it is possible to monitor a selling status of a predetermined product and to provide information corresponding to the selling status to a provider of the predetermined product in a mall-type shopping site not under its control.

### BRIEF DESCRIPTION OF DRAWINGS

FIG. 1 is a schematic diagram schematically illustrating a network configuration of a monitoring system according to an embodiment of the present invention and an example of a shopping mall;

FIG. 2 is a functional block diagram illustrating functions of the monitoring system according to the present embodiment;

FIG. 3 is a diagram illustrating an example of data stored in a whitelist storage unit in the monitoring system according to the present embodiment;

FIG. 4 is a processing flowchart illustrating an example of a flow of processing executed by the monitoring system according to the present embodiment; and

FIG. 5 is a processing flowchart illustrating another example of a flow of processing executed by the monitoring system according to the present embodiment.

### DETAILED DESCRIPTION

### • Overview

Hereinafter, a monitoring device according to an embodiment of the present invention will be described with reference to the drawings.

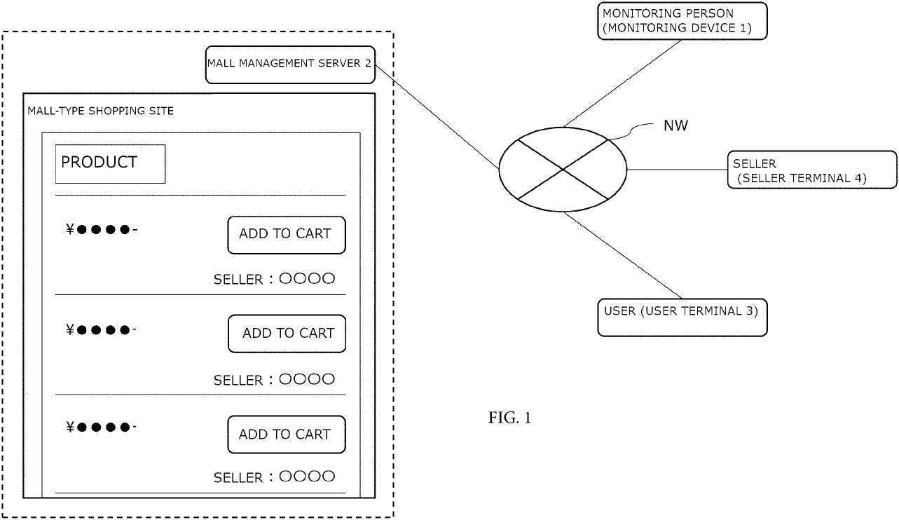

As illustrated in FIG. 1, a monitoring system 1 according to the present embodiment is a system that monitors a selling status of a product provided by a provider of a predetermined product in a mall-type shopping site.

Here, the mall-type shopping site is a website on which a product is sold by one or a plurality of seller different from a site operator among EC sites that sell products and services on the Internet.

In the mall-type shopping site assumed in the present embodiment, a web page (hereinafter referred to as “product sales page”) for introducing and selling a product is provided for each product being handled. From the product sales page, it is possible to grasp, in a list form, information on all the sellers selling the listed products, and information such as the price of the products sold by each seller.

In addition, in the product sales page, a cart is provided for each seller. Information that can identify the seller is associated with the cart, and when a person who desires to purchase a product designates the cart provided for each seller, the product sold by the designated seller is added to the cart.

Note that the “cart” herein is an electronic object for adding a product to a purchase target list. When the person who desires to purchase a product adds a product to the purchase target list by the cart designation operation, the person who desires to purchase the product separately performs an operation of requesting settlement processing to purchase the product.

The monitoring person who operates the monitoring system 1 provides the user with a product monitoring service using the monitoring system 1. In the provision of the monitoring service, a web site (hereinafter, referred to as a “service site”) for user convenience is provided, and the user confirms various types of information on the service site, and provides information necessary for receiving the provision of the monitoring service.

### Functional Configuration

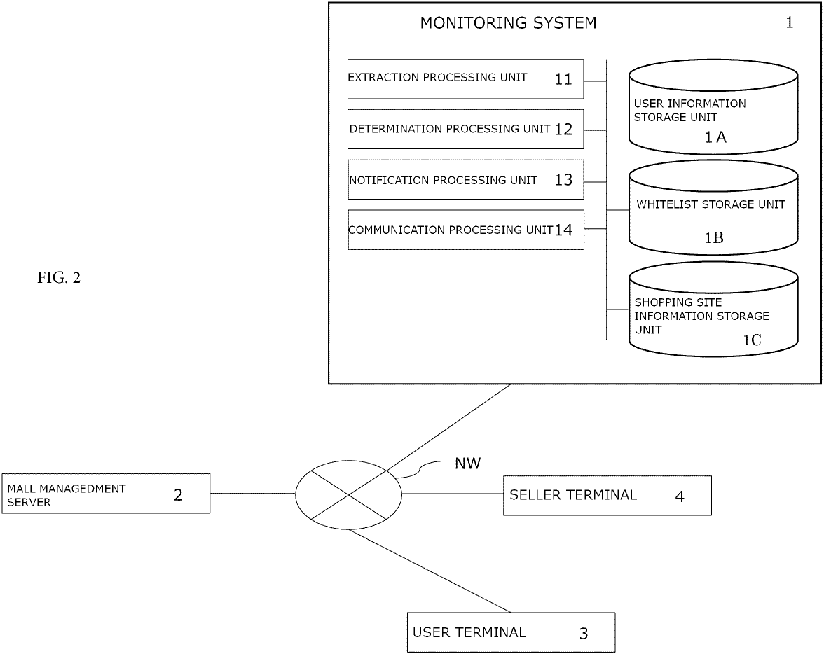

As illustrated in FIG. 2, the monitoring system 1 is configured to be communicable with a mall management server 2 that provides a mall-type shopping site and a user terminal 3 that is a provider of a predetermined product and is used by a user of the system via a network NW such as the Internet.

In addition, a seller who sells a product on the mall-type shopping site can access the mall management server 2 via the network NW using a seller terminal 4 to sell a product.

The monitoring system 1 is realized by executing a predetermined computer program in, for example, a personal computer, a tablet terminal, a smartphone, or the like, and a part or all of the functions thereof may be realized by a cloud computer. In addition, the monitoring system 1 may include a plurality of hardware configurations.

In the monitoring system 1, hardware resources such as a central processing unit (CPU), a random access memory (RAM), a read only memory (ROM), and a hard disk drive, and software resources such as a computer program executed by the CPU constitute a functional unit including a user information storage unit 1A, a whitelist storage unit 1B, a shopping site information storage unit 1C, an extraction processing unit 11, a determination processing unit 12, a notification processing unit 13, and a communication processing unit 14.

The user information storage unit 1A is a storage unit that stores information regarding a user of a monitoring service provided by the monitoring system 1.

Note that the user mentioned here is usually a monitoring service user and a provider of a product sold on a mall-type shopping site such as a product manufacturer. The product provided by the user is sold on the mall-type shopping site via the seller. However, the user himself/herself may become a seller of a product.

The user information storage unit 1A stores information regarding a product provided by the user in addition to basic information such as the name and attribute of the user. The information regarding the product may be at least information that can identify the product when referring to the selling information of the product extracted from the mall-type shopping site, and includes product identification information and the like individually given in the mall-type shopping site in addition to the name and product number of the product. For example, when the mall-type shopping site is Amazon (registered trademark), the product identification information may be ASIN (Amazon Standard Identification Number). Examples of other identification information include a JAN code, an ISBN code, and the like.

The whitelist storage unit 1B is a storage unit that stores a whitelist in which a user lists a seller who is recognized as an appropriate seller of a predetermined product.

Here, the appropriate seller assumed here is a seller who has received the provision of the product from the supplier of the product through a proper route such as wholesale, and on the other hand, the inappropriate seller is a seller who sells the product from a sales route not recognized by the supplier of the product, such as resale and parallel import of the product. The inappropriate seller also includes a seller who sells a counterfeit product of a product.

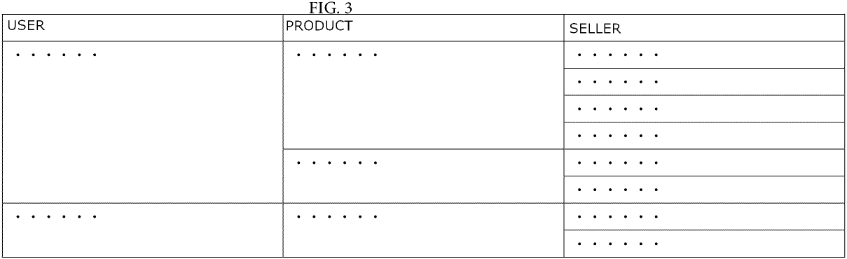

For example, as illustrated in FIG. 3, the whitelist storage unit 1B stores, for each user, a list of products provided by the user and sellers permitted as an appropriate seller of the product.

In the present embodiment, the seller listed in the whitelist is, for example, a wholesale destination of a product. When the seller is a wholesale destination, the name and the identification number of a wholesaler of the wholesale destination, a contact address of the wholesaler, and the like are appropriately stored as information related to the seller. In addition, in this case, the product associated with the seller is a product distributed to a wholesale destination by a provider of the product, and predetermined identification information given to the product may be associated with the product.

In addition, the seller may also be a person arbitrarily designated by the user. Furthermore, the whitelist can include the user himself/herself.

This whitelist may be edited and registered by the user from the service site.

The shopping site information storage unit 1C is a storage unit that stores information on a mall-type shopping site.

The shopping site information storage unit 1C stores, for example, information for identifying a mall-type shopping site, and an address such as a URL for accessing the mall-type shopping site.

The extraction processing unit 11 executes extraction processing of accessing the mall-type shopping site and extracting selling information of a predetermined product on the site.

The selling information extracted in the extraction processing may include, for example, information related to a seller of a predetermined product, information related to a cart generated for the predetermined product, information included in a product sales page, information related to a selling time or a sales status of the product, and the like.

Here, in the case of the mall-type shopping site, there is a case where a plurality of sellers sells products having the same identification information. Each seller may be able to set different selling prices and shipping costs for the same product. The purchaser can designate a seller to purchase and purchase the product. In such a situation, by acquiring the selling information, the user who is a provider of the product can easily monitor the product and analyze the distribution.

In addition, the extraction processing unit 11 crawls the mall-type shopping site at a predetermined timing and scrapes the selling information of a predetermined product, but the timing is not particularly limited, and may be a constant timing or an arbitrary timing set by the monitoring person or the user.

Note that the extraction processing unit 11 may also acquire the trading history of the product in addition to the selling information. The trading history includes, for example, identification information of a sold product, the number of purchases, the number of products, a selling price, a shipping cost, a delivery agent, a delivery method, a sales date and time, and information on a purchaser. In addition, the trading history may have information on a product simultaneously purchased on the mall-type shopping site.

In addition, the extraction processing of the selling information of the predetermined product by the extraction processing unit 11 is realized by, for example, execution of a function of an application programming interface (API) provided in a mall-type shopping site or an API provided by a third party. The extraction processing unit 11 may extract the information such as the selling information from the mall management server 2 by executing the function of the API, or may acquire the information from the purchase screen displayed on the terminal of the purchaser by the mall management server 2. In this case, the extraction processing unit 11 includes, for example, a character information extraction unit that acquires a source code of the purchase screen, and an image extraction unit that extracts an image included in the purchase screen or a search result screen on which links of a plurality of product sales pages are displayed. The extraction processing unit 11 may acquire a portion indicating the display image from the source code, or may acquire image data indicated by the display image.

Further, the extraction processing unit 11 may search for a product image included in the selling information of a product in the mall-type shopping site, and extract a product same as or similar to a predetermined product by an appropriate image recognition technology. AI technology can be applied to image recognition. The product image refers to all the images listed as image data in the image display area of the mall-type shopping site, and may be, for example, a package picture of a product or a picture of the product itself, only a character such as a product name, a logo, or a catch phrase, or a combination thereof. According to this configuration, it is possible to extract a case where different pieces of product identification information are given despite the same product, and the selling information of the counterfeit product.

It is highly probable that a photograph of a product similar to the search target product, a package photograph, a product name, a logo, a catch phrase, or the like is used as the product image of the counterfeit product. In addition, there is also a case where a seller of a counterfeit product processes and uses a product image. Since there are many cases where a purchaser who intends to purchase a product purchases the product by using a product image as a trigger, a counterfeit product having a similar product image is particularly malicious since it inhibits purchase of a genuine product. Therefore, according to the present configuration, it is possible to contribute to safe and fair transaction of genuine products.

The extraction processing unit 11 may extract a product image partially including predetermined information such as a package photograph, a photograph of a product itself, a product name, a logo, or a catch phrase. In this case, the extraction processing unit 11 may also extract information in which the display magnification of the predetermined information has been changed. According to such a configuration, even when a seller who performs reselling or counterfeit selling processes and uses a proper product image, it is possible to accurately extract the product image.

Note that the extraction processing unit 11 may extract the product image by applying OCR technology and reading characters included in the product image. According to this configuration, even in a case where only character contents such as a product name match in an image, extraction can be performed with high accuracy.

The extraction processing unit 11 may perform the above-described image search on the product image displayed on the search result screen after performing the product search on the mall-type shopping site. The extraction processing unit 11 executes a search using a category or a general name of a search target product as a search word. This search word may be registered, for example, when the user registers the search target product, or may be determined with reference to the history of the search word used by the purchaser who has purchased the search target product to reach the product. In addition, a plurality of search words may be registered for one search target product. According to this configuration, the counterfeit product can be efficiently extracted with high accuracy, and the load of the calculation processing and the calculation time are reduced.

Note that a plurality of product images may be associated with one product sales page. In this case, the extraction processing unit 11 may perform image search on a plurality of product images. Furthermore, the extraction processing unit 11 may perform image search on the image displayed on the search result screen.

The product search by the extraction processing unit 11 is executed by an algorithm similar to a search algorithm used by a purchaser who intends to purchase a product on a mall-type shopping site. In general, a purchaser purchases a product after searching on a mall-type shopping site. According to this configuration, a product suspected of being a counterfeit product can be extracted from a product image appearing on a screen that the purchaser actually browses.

The determination processing unit 12 executes determination processing of determining the presence of inappropriate selling for a predetermined product on the basis of the selling information extracted by the extraction processing unit 11.

In an example of a specific aspect, the determination processing unit 12 refers to the whitelist on the basis of the selling information and determines the presence of inappropriate selling on the basis of the presence of selling by a seller other than an appropriate seller of a predetermined product. That is, when there is a seller other than the seller listed in the whitelist on the product sales page, it is determined that inappropriate selling is performed.

In addition, in another example of the specific aspect, the determination processing unit 12 refers to the whitelist on the basis of the selling information and determines the presence of inappropriate selling on the basis of the presence of acquisition of the cart by the seller other than the appropriate seller of the predetermined product. That is, in a case where a cart is generated for selling by a seller other than the seller listed in the whitelist on the product sales page, it is determined that inappropriate selling is performed.

Note that the determination processing described as the examples of the specific aspect may be selectively executed or may be executed in combination.

Further, the determination processing unit 12 may determine whether the product identification information is the product identification information grasped by the user with reference to the product identification information included in the whitelist on the basis of the product identification information of the product extracted by the image search of the extraction processing unit 11. This is because there is a high probability that a product to which product identification information that is not included in the whitelist is added despite being extracted by image search is a counterfeit product.

The notification processing unit 13 executes notification processing of notifying the user terminal 3 of the user who is a provider of the predetermined product of inappropriate selling.

Note that the notification to the user may be performed on a service site or may be performed via another service such as a chat tool or an SNS, an e-mail, or the like.

In addition, the notification to the user may be executed only when inappropriate selling is recognized, or the determination result may be notified each time the determination processing is executed regardless of the presence of inappropriate selling.

The notification processing unit 13 may also notify the user of the URL of the product sales page of the product to which the product identification information that is not included in the whitelist despite being extracted by the image search is added. At this time, the notification mode may be changed according to the similarity in the image search. For example, the product images may be listed in descending order of similarity and transmitted to the user terminal 3. In addition, the notification processing unit 13 may also notify of the site information of the inflow source flowing into the URL. The inflow source site may be, for example, an SNS. Furthermore, in the case of inflow from a service site that displays a purchase URL of a product by photographing the product, the notification processing unit 13 may notify of information specifying the service site that associates the image information of the product with the purchase URL.

In addition, the notification processing unit 13 may notify a seller of inappropriate selling instead of or in addition to the notification to the user terminal 3. The notification processing unit 13 transmits a message for requesting, for example, withdrawal of selling to a seller of inappropriate selling. The notification processing unit 13 may transmit a message via a platform prepared in the mall-type shopping site, or may refer to information of the seller and transmit an e-mail or a direct message on the SNS. The seller information may be acquired by extraction or the like by API.

In addition, the notification processing unit 13 may be configured to notify the operator of the mall-type shopping site.

The communication processing unit 14 is a functional unit that executes transmission and reception of information via the network NW such as the Internet.

The communication processing unit 14 enables the monitoring system 1 to access the mall-type shopping site to extract information and to transmit information to the user terminal 3.

The mall management server 2 receives selling of a plurality of products from a plurality of seller. In addition, the mall management server 2 manages a purchase screen of a sold product, and displays the purchase screen on the terminal according to an operation from the terminal of the purchaser. The mall management server 2 manages information on products purchased via the mall-type shopping site and information on purchasers who have purchased the products.

The user terminal 3 is a terminal used by a user of the monitoring service as a provider of a predetermined product, and is configured to be communicable with the monitoring system 1 via the network NW.

The user terminal 3 is realized by a so-called personal computer and a smart device such as a tablet terminal or a smartphone, and includes an information input/output unit, a browser program for executing transmission/reception of information, and the like.

With the user terminal 3, the user can grasp information related to a seller of a predetermined product on the service site, and receive a notification that there is inappropriate selling from the monitoring system 1.

The seller terminal 4 is a terminal used by a seller who sells a predetermined product on a mall-type shopping site, and is configured to be communicable with the mall management server 2 via the network NW.

Similarly to the user terminal 3, the seller terminal 4 is realized by a so-called personal computer and a smart device such as a tablet terminal or a smartphone, and includes an information input/output unit, a browser program for executing transmission/reception of information, and the like.

The seller accesses the mall-type shopping site by the seller terminal 4 and sells a product.

The purchase screen displays a name of a product, an explanatory image of the product, an advertisement of another product related to the product, a review of the product, information of a seller set as a prescribed value, and the like. However, the display of the purchase screen is created and edited by the mall management server 2, and is changed as needed by selling by a new seller or posting of review by a purchaser. In addition, the advertisement of another product is changed as needed due to entry of a new advertiser, input of advertisement rates of existing advertisers, change of an image presented by an advertiser, or the like. Moreover, the purchase screen is a screen that the purchaser always browses when making a decision to purchase. Therefore, according to the configuration in which the information on the purchase screen is acquired by the extraction processing unit 11, it is possible to check the screen viewed by the purchaser at the time of purchase backward, and to appropriately grasp the situation when the purchaser has made a decision to purchase.

Here, in a case where the extraction processing unit 11 periodically acquires the information of the purchase screen and detects that there is a change in the purchase screen, the determination processing unit 12 may execute determination processing of determining whether there is inappropriate selling for the predetermined product. In addition, whether or not there is a change in the selling status may be further determined from the change in the purchase screen, and when there is a change in the selling status, the determination processing unit 12 may execute determination processing of determining whether or not there is inappropriate selling for a predetermined product.

### Flow of Processing (1)

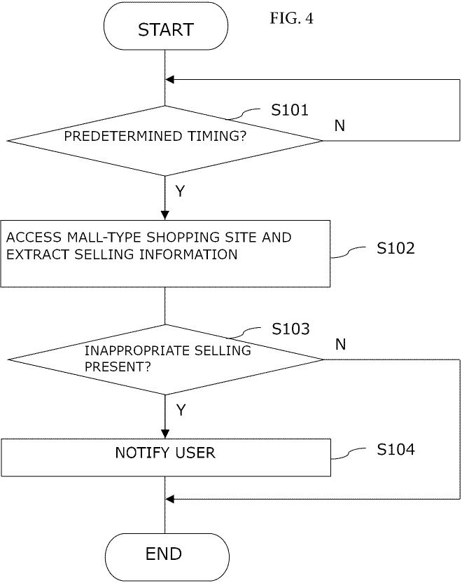

Next, a flow of processing by the monitoring system 1 according to the present embodiment will be described with reference to FIG. 4.

When a predetermined timing such as a constant cycle arrives (S101), the monitoring system 1 accesses the mall-type shopping site and the extraction processing unit 11 extracts the selling information of the predetermined product (S102).

The determination processing unit 12 determines the presence of inappropriate selling for a predetermined product based on the selling information extracted by the extraction processing unit 11 (S103).

Specifically, the determination processing unit refers to the whitelist on the basis of the selling information and determines the presence of inappropriate selling on the basis of the presence of selling by a seller other than an appropriate seller of a predetermined product, or determines the presence of inappropriate selling on the basis of the presence of acquisition of a cart by a seller other than an appropriate seller of a predetermined product.

As a result of the determination, when selling has been performed by a seller other than the seller listed in the whitelist on the product sales page, or when a seller other than the seller listed in the whitelist has acquired a cart, the notification processing unit 13 notifies the user that inappropriate selling has been performed (S104).

Note that the notification to the user may be performed on a user page (so-called my page) on a service site, or may be performed via another service such as a chat tool or an SNS, an e-mail, or the like.

In addition, in the processing illustrated in FIG. 4, only when it is determined that selling of a predetermined product by a seller other than an appropriate seller is performed, the fact is notified to the user, but the present invention is not limited thereto, and the determination result may be notified to the user each time.

The user who has grasped the selling of the predetermined product by the inappropriate seller from the monitoring system 1 can request the site operator or the like of the mall-type shopping site to correct the selling status or directly call attention to the inappropriate seller.

Note that the user’s response to such an inappropriate seller may be executed by a supervisor who operates the monitoring system 1 on behalf of the user. In this case, for example, the monitoring system 1 transmits, to the mall management server 2, a notification for requesting regulation of selling together with a predetermined product and information on an inappropriate seller, or transmits a notification for requesting regulation of selling to the seller terminal 4 of the inappropriate seller.

### Flow of Processing (2)

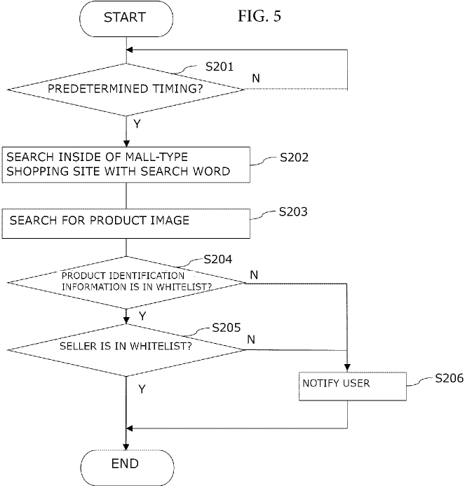

Next, another example of the flow of processing by the monitoring system 1 according to the present embodiment will be described with reference to FIG. 5.

When a predetermined timing such as a constant cycle arrives (S201), the monitoring system 1 searches the inside of the mall-type shopping site with a predetermined search word (S202). Next, the extraction processing unit 11 performs image search on the basis of the image of the product displayed in the search result, and extracts a product sales page suspected of being a resale product or a counterfeit product (S203).

Next, the determination processing unit 12 determines whether the product identification information of the product sales page extracted in S203 is listed in the whitelist (S204), and when the product identification information is not listed in the whitelist, the notification processing unit 13 notifies the user of the product identification information (S205).

In the case of being listed in the whitelist in S204, the presence of inappropriate selling is determined based on the presence of selling by a seller other than an appropriate seller of a predetermined product with reference to the whitelist based on the selling information (S205). In addition, similarly to S103 of FIG. 4, the presence of inappropriate selling may be determined based on the presence of acquisition of the cart by the seller other than the appropriate seller of the predetermined product.

As a result of the determination, when selling has been performed by a seller other than the seller listed in the whitelist on the product sales page, or when a seller other than the seller listed in the whitelist has acquired a cart, the notification processing unit 13 notifies the user that inappropriate selling has been performed (S206).

In S206, the notification mode may be different between the case where the product identification information is not listed in the whitelist in the process of S204 and the case where the seller is not listed in the whitelist in the process of S205.

According to the monitoring system 1 according to the present embodiment described above, it is possible to monitor whether the predetermined product is not sold on the mall-type shopping site by a dealer or the like not authorized by a provider of the predetermined product, and to prevent the transaction of the predetermined product by an inappropriate seller. As a result, it is possible to regulate a situation in which resale products, parallel import products, or inferior counterfeit products are sold to users of the mall-type shopping site in the mall-type shopping site.

In particular, the provider of the product can grasp the selling status of the product in the mall-type shopping site that is not operated by the provider, and realize the safe and fair transaction of the product provided by the provider without consuming a large amount of labor.

### • Other Embodiments

In the monitoring system (hereinafter, for convenience of description, it is referred to as a “monitoring system 5”) according to another embodiment of the monitoring system 1 described above, the determination processing unit 12 may determine the presence of an inappropriate product by comparing the price of a predetermined selling product with a predetermined proper price.

Such determination processing by the determination processing unit 12 can be performed on the basis of information related to a price set by the seller for a predetermined product among the selling information extracted by the extraction processing unit 11 from the mall management server 2.

Note that the predetermined appropriate price may be settable by the user from the service site, or may be a value having a certain range based on, for example, an average value of prices set for a predetermined product on the mall-type shopping site in a certain period.

The determination processing in the monitoring system 5 according to the present embodiment can be executed in appropriate combination with the determination processing in the monitoring system 1 described above.

What is claimed is:

1. A monitoring system that is communicably connected to a mall management server that provides at least a mall-type shopping site via a network and monitors the mall-type shopping site, the system comprising:
an extraction processing unit that accesses the mall-type shopping site and extracts a product having an image same as or similar to at least a part of an image of a predetermined product; and
a determination processing unit that determines presence of inappropriate selling for the predetermined product based on selling information of the extracted product; wherein
the extraction processing unit performs a product search on the mall-type shopping site with reference to a history of a search word used by a purchaser who has purchased the predetermined product to reach the predetermined product, and extracts a product having an image same as or similar to at least a part of an image of the predetermined product from an image displayed as a search result.

2. The monitoring system according to claim 1, wherein the selling information includes at least product identification information for identifying the predetermined product,
the system includes a whitelist storage unit that stores a whitelist related to product identification information of the predetermined product, and
the determination processing unit determines a product extracted by the extraction processing unit and having no appropriate product identification information of the predetermined product as an inappropriate selling with reference to the whitelist on the basis of the selling information.

3. The monitoring system according to claim 1, wherein
the system is configured to be communicable with a user terminal used by a user of a service provided by the monitoring system via a network, and
the system further includes a notification control unit configured to notify the user terminal of a URL of a product sales page on which the inappropriate selling is performed.

4. The monitoring system according to claim 1, wherein
the extraction processing unit executes the product search using an algorithm similar to a search algorithm used by the purchaser.

5. A monitoring method for allowing a system communicably connected to a mall management server that provides at least a mall-type shopping site via a network to monitor the mall-type shopping site, the method allowing the system to execute: extraction processing of accessing the mall-type shopping site and extracting a product having an image same as or similar to at least a part of an image of a predetermined product; and
determination processing of determining whether there is inappropriate selling for the predetermined product based on selling information of the extracted product, wherein
in the extraction processing, a product search is performed on the mall-type shopping site with reference to a history of a search word used by a purchaser who has purchased the predetermined product to reach the predetermined product, and a product having an image same as or similar to at least a part of an image of the predetermined product is extracted from an image displayed as a search result.

6. A non-transitory computer medium for a monitoring system that is communicably connected to a mall management server that provides at least a mall-type shopping site via a network and monitors the mall-type shopping site, the non-transitory computer medium allowing the system to execute: extraction processing of accessing the mall-type shopping site and extracting a product having an image same as or similar to at least a part of an image of a predetermined product; and
determination processing of determining whether there is inappropriate selling for the predetermined product based on selling information of the extracted product, wherein
in the extraction processing, a product search is performed on the mall-type shopping site with reference to a history of a search word used by a purchaser who has purchased the predetermined product to reach the predetermined product, and a product having an image same as or similar to at least a part of an image of the predetermined product is extracted from an image displayed as a search result.
